(19) United States
(12) Patent Application Publication
(10) Pub. No.: US 2013/0007749 A1
(43) Pub. Date: Jan. 3, 2013

(54) METHOD AND APPARATUS FOR MANAGING A WORKING TASK BASED ON A COMMUNICATION MESSAGE

(75) Inventors: Chang Yan Chi, Beijing (CN); Lin Luo, Beijing (CN); Wen Peng Xiao, Beijing (CN); Min Yang, Beijing (CN)

(73) Assignee: International Business Machines Corporation, Armonk, NY (US)

(21) Appl. No.: 13/572,011

(22) Filed: Aug. 10, 2012

Related U.S. Application Data
(63) Continuation of application No. 13/538,213, filed on Jun. 29, 2012.

(30) Foreign Application Priority Data
Jun. 30, 2011 (CN) 201110182171.7

(51) Int. Cl. G06F 9/46

(52) U.S. Cl. 718/100

(57) ABSTRACT

Disclosed is an apparatus for managing a working task based on a communication message. The apparatus may include a rule matching module configured to, in response to receiving a communication message, match the communication message using a matching rule. An application determining module is configured to determine an application managing a working task associated with the communication message according to the matching result. A prompting module is configured to prompt the user to perform an operation on the application managing the working task.

### CROSS-REFERENCE TO RELATED APPLICATIONS

This application claims priority under 35 U.S.C. §119 to Chinese Patent Application No. 201110182171.7 filed Jun. 30, 2011, and under 35 U.S.C. §120 to U.S. patent application Ser. No. 13/538,213 filed Jun. 29, 2012, the entire text of which is specifically incorporated by reference herein.

### TECHNICAL FIELD

The present invention relates to communication messages and, more particularly, to a method and apparatus for manage a working task based on a communication message.

### BACKGROUND

Currently, a work team of a development project usually uses team coordination software to coordinate team members' activities and to manage working tasks of the project team, including creating and updating working task records in the team coordination software. For example, a software development project team usually uses project management software to manage the progress of designing, coding and debugging. A business department usually uses task coordination software to manage and assign to each team member work items to be done by each team member as well as the completion statuses of corresponding tasks.

However, such team coordination software usually requires the team members to immediately record their work states into the system after they accomplish the corresponding work, in order to ensure that the entire coordination process goes on smoothly. However, users will usually not immediately record or update working task records in the team coordination tool software; rather, they will choose to periodically update working task records in the team coordination tool software, which will require each team member to spend extra time and effort to collect data and update it to the team coordination tool software. Usually, such a process of data collection needs to cost a large amount of time and effort, the reason lying in that the user will not only need to frequently switch between a plurality of pieces of software, but also need to recollect the past situations to arrange and summarize the task implementation details to be recorded, which will necessarily make recording and updating the working task records become the user's burden, and since the interval time may be too long, many details of the implementation process will be inevitably lost.

### BRIEF SUMMARY

Based on the above problems, the present invention provides an efficient method for managing a working task based on a communication message.

According to an aspect of the present invention, there is provided an apparatus for managing a working task based on a communication message, the apparatus comprising: a rule matching module configured to, in response to receiving a communication message, match the communication message using a matching rule; an application determining module configured to determine an application managing a working task associated with the communication message according to the matching result; an prompting module configured to prompt the user to perform an operation on the application managing the working task.

According to an embodiment of the present invention, there is provided an efficient method for managing a working task based on a communication message, so that the user's time is saved and the efficiency of working task management is improved.

### BRIEF DESCRIPTION OF THE DRAWINGS

The invention itself, and preferred embodiments and the objectives and advantages thereof will be better understood by referring to the following detailed description of exemplary embodiments when read in conjunction with the accompanying drawings, in which:

FIG. 1 shows a method for managing a working task based on a communication message according to an embodiment of the present invention;

FIG. 2 shows an e-mail message received according to an embodiment of the present invention;

FIG. 3 shows a user interface popped up for prompting the user to perform an update operation according to an embodiment of the present invention;

FIG. 4 shows a block diagram of an apparatus for managing a working task based on a communication message according to an embodiment of the present invention; and

FIG. 5 schematically shows a structural block diagram of a computing device for realizing an embodiment of the present invention.

### DETAILED DESCRIPTION

In the following will be described a method and system for managing a working task based on a communication message according to embodiments of the present invention with reference to the accompanying drawings, through which the objectives and the advantages of the present invention will be better understood.

Embodiments of the present invention include communication software tools, e.g., e-mail software applications or IM software applications, are widely used in the current team work environment, and users use such software to send communication messages to team members, mainly for keeping smooth communication with each team member and timely notifying the assignment and accomplishment conditions of working tasks. An embodiment of the present invention analyzes a communication message, extracts the working task state information included therein, and matches the application managing the working task associated therewith, and timely reminds the user to perform an operation on the application managing the working task.

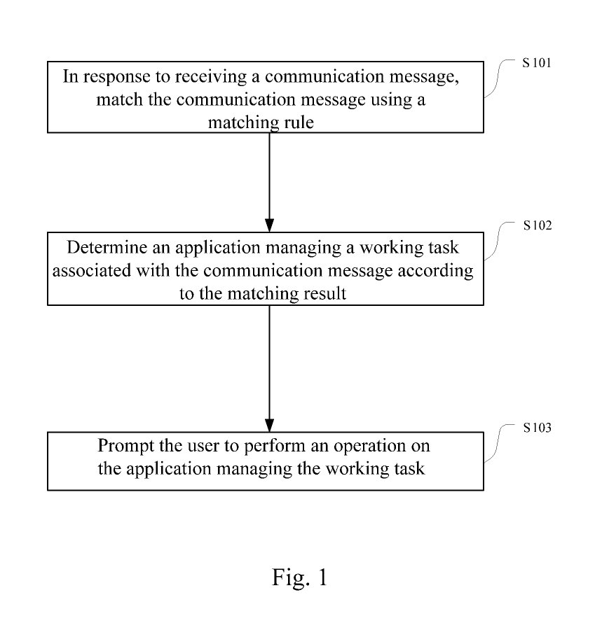

FIG. 1 shows a method for managing a working task based on a communication message according to an embodiment of the present invention, comprising: at step S101, in response to receiving a communication message, matching the communication message using a matching rule; at step S102, determining an application managing a working task associated with the communication message according to the matching result; at step S103, prompting the user to perform an operation on the application managing the working task.

At step S101, in response to receiving a communication message, matching the communication message using a matching rule. According to an embodiment of the present invention, prior to step S101, pre-establishing an association between the matching rule and an application managing a working task. The matching rule can be predefined by the user, or provided by the system; if it is provided by the system, the user can modify it. The matching rule includes at least one search term, and each search term include at least one pre-defined key word related to a respective application managing a working task. The search term in the communication message is searched for; and it is determined whether there is an application managing the working task associated with the communication message according to the searching result. If no search term is retrieved in the communication message, this indicates that the communication message is not related to the application managing a working task; if a search term is retrieved, this indicates that there is an application managing a working task associated with the communication message, and the application managing a working task associated with the communication message is further determined according to the pre-established association relationship between the search term and the application managing the working task. For example, key words can be selected according to the characteristics of the task stored in the database of the application managing the working task; if <fixed> and <bug> appear in a communication message, then the communication message is thought to be related to the application managing software testing, and thus <fixed> and <bug> are defined as the keywords of a search term; if <finish> and <task> appear in a communication message, then the communication message is thought to be related to the application managing the development working task, and thus <finish> and <task> are defined as the keywords of a search term.

According to an embodiment of the present invention, the obtained communication message can be an e-mail message, and a functional plug-in should be added in the client e-mail application to obtain the e-mail messages transmitted/received by the user; in response to detecting the event that the user clicks the button for sending mails/receiving mails, obtaining the e-mail message sent/received by the user; and searching for at least one search term in the obtained mail body of the e-mail message piece by piece. According to an embodiment of the present invention, the received communication message can be an instant communication message, and the client IM application should be added with a functional plug-in to obtain the instant communication message issued/received by the user; in response to detecting the event that the user clicks the button for sending the instant communication message/receiving the instant communication message, obtaining the instant communication message sent/received by the user, and searching for the at least one search term in the mail body of the obtained e-mail message piece by piece.

According to an embodiment of the present invention, the above association relationship can be established by pre-constructing a search base, which includes at least one search term, each search term including at least one predefined key word related to a respective application managing a working task. A unique identification ID is generated for each search term, and search terms are associated with applications managing working tasks via the IDs of the search terms. Taking table 1 as an example, it shows search terms pre-defined according to the embodiments of the present invention, including four search terms: ID1 and ID2 correspond to application 1, ID1 including a combination of two key words: <finish> and <task>, and ID2 including a combination of two key words, <todo> and <task>; and ID3 and ID4 correspond to application 2, ID3 including a combination of two keywords: <fixed> and <bug>, and ID 4 including a combination of two keywords: <fixed> and <defect>.

TABLE 1

| search term | | associated |
|---|---|---|
| ID | search term | application |
| ID1 | <finish> and <task> | Application 1 |
| ID2 | <todo> and <task> | Application 1 |
| ID3 | <fixed> and <bug> | Application 2 |
| ID4 | <fixed> and | Application 2 |
| | <defect> | |

The matching rule according to an embodiment of the present invention includes a self-defined matching condition according to the user's requirement, and the matching condition is applied to the communication message to obtain a character strings in line with the matching condition. Taking table 2 as an example, it shows pre-defined matching conditions corresponding to application 1 and application 2 according an embodiment of the present invention, wherein the matching condition corresponding to application 1 is: <name>+<working task description>. Name extraction can be achieved through the name entity recognition (NER) technology, which refers to identifying entities having specific significance in a text, mainly including names of persons, names of places, names of institutions, proper nouns, etc. Name entities in English have an obvious formal indication (i.e., the first letter of each word in an entity should be capitalized), and thus entity boundary recognition is easy, and the emphasis point is to determine the types of entities. Compared with English, the task of Chinese name entity recognition is more complex, and compared with the sub-task of entity type labeling, the recognition of entity boundaries is more difficult. There are various methods in the prior art to realize name entity recognition, which are not be repeated herein. The <working task description> is defined specifically as: ‘task’+<any character combination>+<punctuation>. The matching condition is applied to the communication message to search for a character string in line with the matching condition; if one is in line with the matching condition, then the relevant information of the working task corresponding to application 1 is obtained: name and working task description. The matching condition corresponding to application 2 is: <name>+<bug identification>, wherein <bug identification> is defined specifically as: ‘bug’+<any character combination>+<punctuation>. The matching condition is applied to the communication message to search for a character string in line with the matching condition; if one is in line with the matching condition, then the relevant information of the working task corresponding to application 2 is obtained: name and bug identification. Those skilled in the art will appreciate that pre-defined matching conditions can be stored, maintained and set according to a user's requirement.

Those skilled in the art will understand that if character strings in line with some complex rules are searched for, then a regular expression can be used to describe the complex rules. Regular expressions were first proposed by mathematician Stephen Keene in 1956 based on incremental research results of natural languages. After development in several periods, a standard of regular expressions has been approved by the ISO (International Standards Organization) and recognized by the Open Group organization. Currently, regular expressions are widely applied in computer and information science technologies. For example, when character strings or web pages are written and processed, it is often needed to look up character strings in line with some complex rules, and a regular expression is a tool that can well describe such complex rules. For example, a regular expression “(̂task)(a−z)|(A−Z)|(\d){10}” is used to express “all the character strings starting with “task” and of a length of 10″. Wherein, “̂” denotes starting matching from the start of the row, “(a−z)” denotes any character matching a to z, “(\d)” denotes matching any numeral, “|” denotes the logic “or”, and “{10}” denotes repeating 10 times. If the user desires to search for a character string starting with “task” and of a length of 10 from the communication message, he can use this expression to match a specific attribute, thus defining a matching condition.

In addition, the expression forms of various databases can be used to establish the association between search terms and applications managing working tasks, as well as the association between applications managing working tasks and relevant information of working tasks, rather than the present invention being limited to the implementation as shown in table 1 and table 2.

TABLE 2

| | Relevant | |
|---|---|---|
| | information of | |
| | the working | |
| Application | task | Matching condition |
| application 1 | Name, working | <name> + <working task |
| | task | description> |
| | description | working task |
| | | description: ‘task’ + <any |
| | | character |
| | | combination> + <punctuation> |
| application 2 | Name, bug | <name> + <bug |
| | identification | identification> |
| | | bug |
| | | identification: ‘bug’ + <any |
| | | character |
| | | combination> + <punctuation> |

At step S102, determining the application managing a working task associated with the communication message according to the matching result, wherein it further comprises using the working task information obtained at step S101 to query whether there is, in the database of the application managing the working task, a matching working task record. Specifically, in the application managing the working task, a database recording relevant information of the working task will be maintained, and the database includes a plurality of working task records, each of which includes a plurality of fields representing task record attributes and features. Each task record corresponds to a unique task record identification. Taking table 3 as an example, it has four working task records, and the attribute information of a task record includes: task ID, person in charge, task description and finish time. After the working task information related to the application managing the working task is obtained, the working task information is used as a search condition to search in the database of the application managing the working task to determine whether there are a matching working task record.

TABLE 3

| | | Task | |
|---|---|---|---|
| Task ID | Person in charge | description | Finish time |
| ID1 | Wang ming | task of writing | 2011-6-30 |
| | | the system | |
| | | design document | |
| ID2 | Li gang | task of | 2011-12-30 |
| | | finishing the | |
| | | main module | |
| | | programming | |
| ID3 | Liu jian | task of | 2012-4-30 |
| | | finishing the | |
| | | code compiler | |
| | | and debugging | |

At step S103, prompting the user to perform an operation on the application managing the working task. At this time, a dialogue box will pop up on the client interface to prompt the user whether he wants to perform an operation on the application managing the working task. According to an embodiment of the present invention, if a matching working task record is found at step S102, then the user is prompted to perform an update operation on the matching working task record; if no matching working task record is found, the user is prompted to create a new working task record.

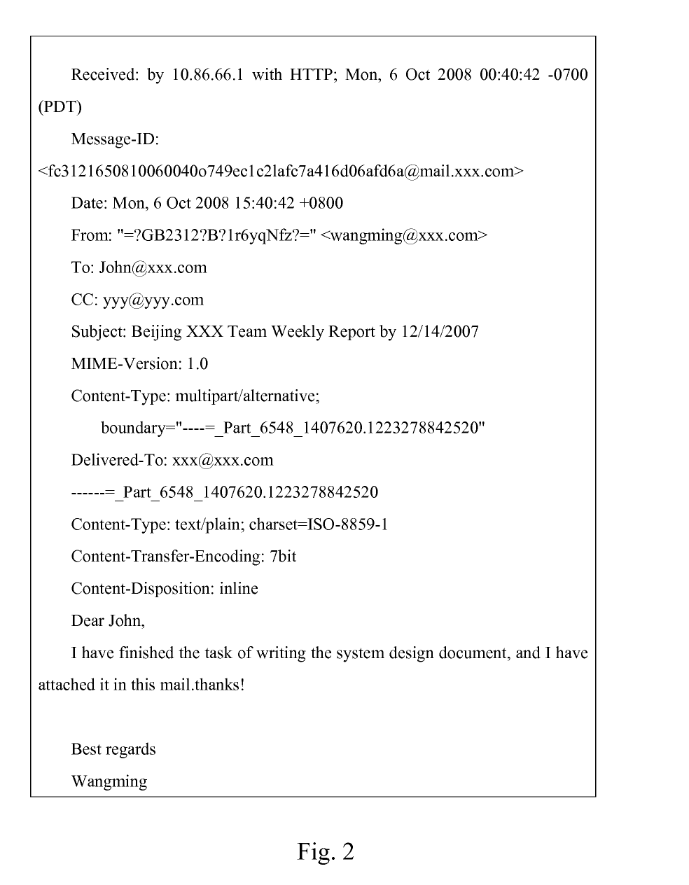

In the following will be described a method for managing a working task based on an e-mail message according to an embodiment of the present invention in conjunction with Table 1, Table 2 and Table 3. FIG. 2 shows an e-mail message received according to an embodiment of the present invention, and the content of the received e-mail message is in the MIME format, that is, multipurpose Internet Mail Extension format, including a mail header and mail body.

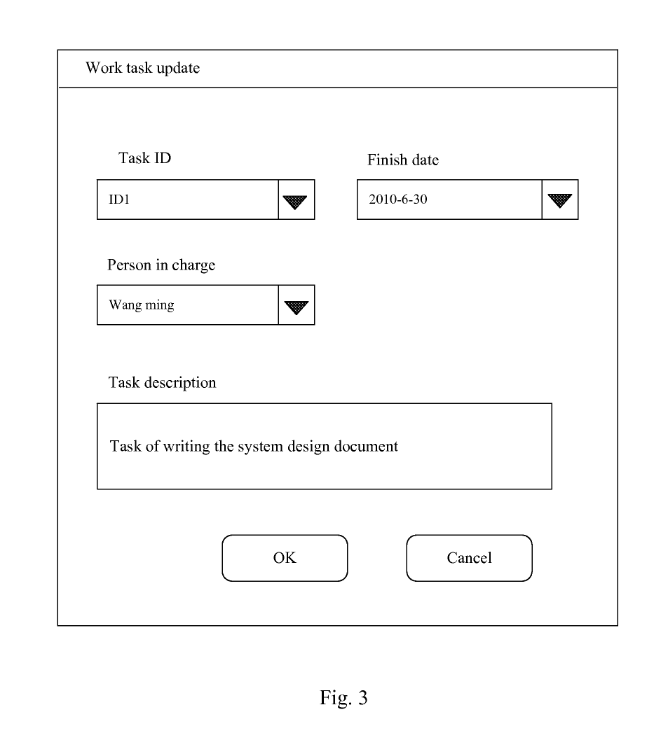

First, searching for the pre-defined search terms ID1, ID2, ID3 and ID4 in table 1 one by one in the mail body, and finding out that the mail body contains the keywords of the search term ID1: <finish> and <task>. By querying Table 1, it is determined that the application managing the working task related to the e-mail message is application 1. Then proceeding to search Table 3, finding out that the matching condition corresponding to application 1 is: <name>+<working task description>, wherein the <working task description> is specially defined as: ‘task’+<any character combination>+<punctuation>. Then applying the matching condition corresponding to application 1 to the message body to find out the character string in line with the matching conditions: I task of writing the system design document, wherein by querying the sender's registration information, “I” is corresponded to the name of the sender “wang ming”, and thus the working task information related to application 1 is obtained: the name is “wang ming”, and the working task description is “task of writing the system design document”. Further, the working task information is used as a search condition to search in the database of application 1 to determine whether there is a matching working task record, and a matching working task record task ID1 is found, and then the user is prompted to perform an update operation on the matching working task record. FIG. 3 shows a user interface popped up for prompting the user to perform an update operation according to an embodiment of the present invention, wherein it includes the attributes and related information extracted from the matching working task record, and the user can change the related information of the working task record attributes on the interface, so as to realize management of the working task.

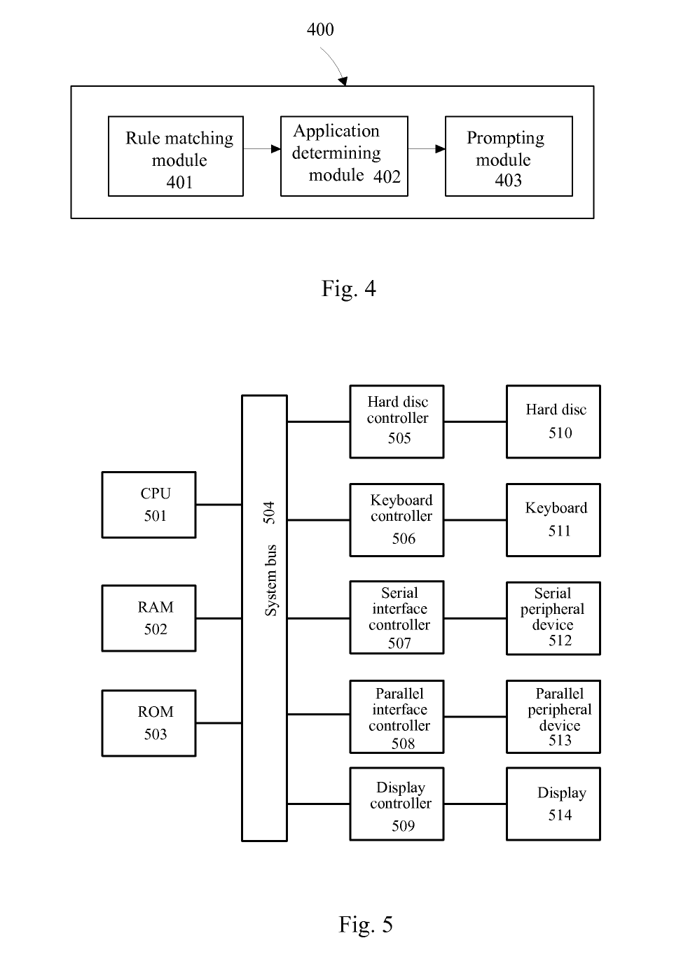

Based on the same inventive concept, the present invention provides an apparatus for managing a working task based on an e-mail message. FIG. 4 shows a block diagram of an apparatus for managing a working task based on an e-mail message according to an embodiment of the present invention. Apparatus 400 comprises: a rule matching module 401 configured to, in response to receiving a communication message, match the communication message using a matching rule; an application determining module 402 configured to determine a application managing a working task associated with the communication message according to the matching result; an prompting module 403 configured to prompt the user to perform an operation on the application managing the working task.

According to an embodiment of the present invention, the apparatus further comprises an association establishing module configured to pre-establish an association between the matching rule and the application managing the working task.

According to an embodiment of the present invention, the matching rule includes at least one search term, wherein the matching rule application module is further configured to: search for the search term in the communication message; determine whether there is an application managing a working task associated with the communication message according to the search result.

According to an embodiment of the present invention, the rule matching module 401 is further configured to: obtain working task information related to the application managing the working task from the communication message.

According to an embodiment of the present invention, the application determining module 402 is further configured to: use the extracted working task information to query whether there is a matching working task record in the database of the application managing the working task.

According to an embodiment of the present invention, the prompting module 403 is further configured to: in response to finding a matching working task record, prompt the user to perform an update operation on the matching working task record. According to an embodiment of the present invention, the prompting module 403 is further configured to: in response to finding no matching working task record, prompt the user to create a new working task record.

The method and apparatus for managing a working task based on a communication message according to embodiments of the present invention use the working task state information included in a communication message to match an associated application managing the working task, and timely remind the user to perform an operation on the application managing the working task, thus improving the user's working task management efficiency and save the user's time.

FIG. 5 schematically shows a structural block diagram of a computing device for realizing an embodiment of the present invention. The computer system shown in FIG. 5 comprises a CPU (central processing unit) 501, a RAM (random access memory) 502, a ROM (read-only memory) 503, a system bus 504, a hard disc controller 505, a keyboard controller 506, a serial interface controller 507, a parallel interface controller 508, a display controller 509, a hard disc 510, a keyboard 511, a serial peripheral device 512, a parallel peripheral device 513 and a display 514. In these components, the CPU 501, RAM 502, ROM 503, hard disk controller 505, keyboard controller 506, serial interface controller 507, parallel interface controller 508 and display controller 509 are connected with the system bus 504. The hard disk 510 is connected with the hard disk controller 505, the keyboard 511 is connected with the keyboard controller 506, the serial peripheral device 512 is connected with the serial interface controller 507, the parallel peripheral device 513 is connected with the parallel interface controller 508, and the display 514 is connected with the display controller 509.

The functions of each component in FIG. 5 are well known in the art, and the structure shown in FIG. 5 is also conventional. Such structure is not only suitable for personal computers, but also for hand-held devices, e.g., Palm PC, PDA (personal digital assistant), mobile phones, etc. In different applications, e.g., when implementing a user terminal comprising a client module according to the present invention or a server host comprising a network application server according to the present invention, some components may be added to the structure shown in FIG. 5, or some components in FIG. 5 may be omitted. The entire system shown in FIG. 5 is usually controlled by computer readable instructions stored as software in the hard disk 510 or in EPROM or another non-volatile storage. The software can also be downloaded via a network (not shown), or stored in hard disk 510, or the software downloaded via the network may be loaded into RAM 502 and executed by CPU 501, so as to accomplish the functions defined by the software.

Although the computer system described in FIG. 5 may support the technical solution provided by the present invention, this computer system is only an example of computer systems, and those skilled in the art will appreciate that many other computer system designs can also realize embodiments of the present invention.

Although exemplary embodiments of the present invention are described herein by referring to the accompanying drawings, it will be understood that the present invention is not limited to the specific embodiments. And, those of ordinary skill in the art can make various changes and modifications to the embodiments of the present invention without departing from the scope and spirit of the present invention. All the changes and modifications are intended to be included in the scope of the present invention defined by the appended claims.

It should be appreciated that at least some aspects of the present invention can be realized by a program product alternatively. The program defining the functions of the present invention can be transmitted to a data storage system or computer system through various signal bearing medium, which includes but not are limited to, non-writable storage medium (e.g., CD-ROM), writable storage medium (e.g., floppy disc, hard disc drive, write/read CD ROM, optical medium), and communication medium such as computer and telephone networks including Ethernet. Therefore, it should be appreciated that such signal bearing medium, when carrying or being encoded with the computer readable instructions for managing the method functions in the present invention, represents an alternative embodiment of the present invention. The present invention can be realized in the manner of hardware, software, firmware or a combination thereof. The present invention can be realized in a computer system in a centralized manner, or in distributed manner in which, different components are distributed in some inter-connected computer systems. Any computer system or other devices suitable for executing the method described in the present text are suitable. Preferably, the present invention is realized in the manner of a combination of computer software and general-purpose computer hardware, in which, the computer program, when being loaded and executed, controls the computer system to make it execute the method of the present invention, or form the system of the present invention.

Description of the preferred embodiments of the present invention are presented above for the purpose of illustration. The above description of the preferred embodiments is not exhausted, nor is it intended to limit the present invention to the disclosed precise form. Obviously, in view of the above teaching, many modifications and changes are possible. For those skilled in the art, it is obvious that such modifications and changes are included in the scope of the present invention defined by the appended claims.

What is claimed is:

1. An apparatus for managing a working task based on a communication message, the apparatus comprising:
a rule matching module configured to, in response to receiving a communication message, match the communication message using a matching rule;
an application determining module configured to determine an application managing a working task associated with the communication message according to the matching result; and
a prompting module configured to prompt the user to perform an operation on the application managing the working task.

2. The apparatus of claim 1, further comprising an association establishing module configured to pre-establish an association between the matching rule and the application managing the working task.

3. The apparatus of claim 2, wherein the matching rule comprises at least one search term.

4. The apparatus of claim 3, wherein the rule matching module is further configured to: search for the search term in the communication message; determine whether there is an application managing a working task associated with the communication message according to the search result.

5. The apparatus of claim 1, wherein the rule matching module is further configured to: obtain working task information related to the application managing the working task from the communication message.

6. The apparatus of claim 5, wherein the application determining module is further configured to: use the obtained working task information to query whether there are a matching working task record in the database of the application managing the working task.

7. The apparatus of claim 6, wherein the prompting module is further configured to: in response to finding a matching working task record, prompt the user to perform an update operation on the matching working task record.

8. The apparatus of claim 6, wherein the prompting module is further configured to: in response to finding no matching working task record, prompt the user to create a new working task record.
